(19) United States
(12) Patent Application Publication
(10) Pub. No.: US 2017/0080327 A1
(43) Pub. Date: Mar. 23, 2017

(54) METHOD AND DEVICE FOR CONDUCTING BLACKJACK-TYPE GAMES

(71) Applicant: AGS, LLC, Las Vegas, NV (US)

(72) Inventors: Ofir Ventura, Las Vegas, NV (US); Garry A. Hamud, Las Vegas, NV (US)

(21) Appl. No.: 14/862,505

(22) Filed: Sep. 23, 2015

(51) Int. Cl. A63F 1/00; G07F 17/32

(52) U.S. Cl. CPC A63F 1/00; G07F 17/3293; G07F 17/3244; A63F 2001/003

(57) ABSTRACT

A method and device for conducting blackjack-type games includes receiving a base wager and dealing at least one initial player hand and an initial dealer hand. A final player hand is formed from each initial player hand. Optionally, if the initial player hand matches a discard criterion, a designated card may be burned from the initial player hand and replaced with a newly dealt card. If a final player hand matches a predefined modified player winning hand, the base wager is rewarded using a predefined pay table either with or without first comparing the final player hand to a final dealer hand. A final dealer hand is formed. If the final dealer hand is a predefined modified dealer bust hand, the base wager is paid less than even money, which may include simply returning the wager. The base wager may otherwise be resolved in a manner consistent with conventional blackjack.

### BACKGROUND

The disclosed embodiments relate to methods and devices for conducting blackjack-type games. More specifically, the disclosed embodiments include methods and devices for conducting blackjack-type games in which certain payouts and/or hand-formation options are modified from conventional blackjack.

Blackjack is a well-known card game played in casinos. The object of the game is to have a final hand total closer to twenty-one than the final dealer hand total without exceeding twenty-one. For purposes of calculating the final hand total, each card has a value equal to its face value except face cards, which have a value of ten, and Aces, which may have a value of eleven or one, depending on which forms the best hand. In conventional blackjack, the suit of the cards is irrelevant. A final hand total that exceeds twenty-one is said to “bust” and is considered a losing hand.

The form of blackjack played in casinos is banked by the house and is played between a dealer, representing the house, and at least one player. In a typical blackjack game, each player makes a base wager in a wagering area on a playing surface. The dealer deals an initial player hand containing two cards to each player and an initial dealer hand containing two cards to himself or herself. The two cards of the initial dealer hand may be dealt together, with one card face up and the other face down, or dealt separately, with a first card dealt before completing the players' hands and a second card dealt after completing the players' hands.

If the initial dealer hand does not have a natural twenty one, any initial player hand receiving a natural twenty-one or blackjack, i.e. a total of twenty-one in the initial dealt hand, is immediately rewarded, typically at a rate of 2:1, 3:2, or 6:5, and play is terminated as to that player. Each remaining player examines his or her initial player hand and decides whether to hit, i.e. receive another card, or stand, i.e. stop with the current hand. A player may hit as many times as the player wishes as long as the player does not bust, i.e. receive a card causing the cumulative sum of the values of the cards in the player's hand to exceed twenty-one. When a player busts, the player's wager is immediately collected and play is terminated as to that player.

A player may have additional options available depending on the initial player hand dealt. For example, a player may have the option to double down. Although the availability of the double down option vary from casino to casino, doubling down allows a player to double the player's wager in exchange for a single additional card dealt to the initial player hand. This option is typically selected when a player feels that he or she has a reasonable chance of winning by drawing only a single card. This is often the case when the player has an initial two-card total of ten or eleven, so that any ten-value card will give the player a total of twenty or twenty-one, or when the dealer has an exposed card of a five or six, and the player feels it likely that the dealer will bust.

A player may also have the option to split the initial player hand. Specifically, if the player receives a pair, i.e. two cards having the same card value, the player may split the pair and use each card as a basis for a separate hand. For example, if a player were to be dealt a pair of eights, the player may choose to split the pair and continue play with two separate hands each containing an eight and an additional dealt card. Each of the individual split hands is played independently, with the player free to hit or stand (or, possibly, split or double down depending on the house rules) the newly formed split hands.

After all the players have formed final hands, the dealer reveals the face-down card in the dealer hand. The dealer completes the dealer hand according to established house rules. That is, the casino uses established rules to eliminate discretion by the dealer in forming the dealer hand and the dealer hits or stands as the house rules dictate. The final dealer hand is compared to each final player hand and the target value of twenty one to resolve the wagers. In resolving the wagers, a player hand outranks or beats a dealer hand if the total sum of the cards in the player hand is closer to twenty-one than the total sum of the cards in the dealer hand is. For example, if the final dealer hand has a total sum of nineteen and a final player hand has a total sum of twenty, the final player hand “wins” because it is closer to the target value of twenty-one than the final dealer hand is. Wagers on winning player hands are typically rewarded at even money, i.e., 1:1. Wagers are collected from player hands with a final hand total further from twenty-one than the final hand total of the dealer hand is. If the dealer hand busts, all players who did not bust or receive a blackjack are rewarded. If the player and dealer push, i.e., have hands with the same final hand total, the player's wager is returned.

### SUMMARY

The disclosed embodiments have been developed in light of the above and aspects of the invention may include a method for conducting a blackjack-type game. In one optional embodiment, at least one base wager is received. In an optional embodiment executed by a device, the base wager may be received through a player interface.

An initial player hand of playing cards is dealt for each base wager. Similarly, an initial dealer hand of playing cards is dealt. In one optional embodiment executed by a device, the initial player hand and/or initial dealer hand may be dealt using a random outcome generator, such as a card shuffling/dealing device, random number generator, data processor, or the like.

At least one final player hand is formed from each initial player hand by standing on the initial player hand or receiving at least one additional playing card dealt to the initial player hand. In an optional embodiment executed on a device, an election may be received through a player interface to stand or hit. If an initial player hand contains playing cards with a sum equal to the target value, the base wager is typically rewarded at a predefined blackjack rate greater than even money. If the sum of the playing cards in a final player hand exceeds a target value, the base wager is collected and play is terminated for the final player hand.

In an optional embodiment, at least one discard criterion may be defined. A determination is made whether any initial player hand meets the at least one discard criterion. An election is received for each initial player hand meeting the at least one discard criterion to either (a) continue the game using the initial player hand or (b) discard a designated playing card from the initial player hand, remove the discarded playing card from play, and receive a replacement playing card in the initial player hand. Discard criterion may be based on the relative values of the cards in the initial player hand. For example, a player may be permitted to discard the player's exposed card if the exposed card is less than the player's hole card. In alternate optional embodiment, the discard criteria and/or the playing card eligible for discard from the initial player hand may vary.

A final dealer hand is formed from the initial dealer hand by standing on the initial dealer hand or receiving at least one additional playing card dealt to the initial dealer hand. In an optional embodiment implemented on a device, the final dealer hand may be formed by a data processor executing program instructions the form a final dealer hand according to house rules.

If the sum of the playing cards in a final dealer hand exceeds a target value, the base wagers are typically rewarded at even money and play is terminated. However, at least one final dealer hand containing playing cards with a sum that exceeds the target value, i.e., a dealer bust hand, is defined to be a modified dealer bust hand. In one such optional embodiment, the modified dealer bust hand is defined based on the quantity of playing cards in the final dealer hand. In an additional or alternate optional embodiment, the modified dealer bust hand is defined based on the value and/or suit of the playing card that causes the final dealer hand to exceed the target value, i.e., causes the final dealer hand to bust. When the final dealer hand matches a modified dealer bust hand, base wagers are returned, rewarded at less than even money, or rewarded at greater than even money without regard to the final player hands. In an optional embodiment implemented on a device, base wagers may be resolved by a data processor executing program instructions according to a method of the present invention.

In an optional embodiment, a side wager or modified “insurance-type” wager may be received. In one such optional embodiment, an award may be issued for each side wager when the final dealer hand is a modified dealer bust hand.

When the sum of the playing cards in the final dealer hand is less than or equal to the target value, any remaining base wagers are resolved by comparing each final player hand to the final dealer hand and the target value. In an optional embodiment conducted using a device, comparisons may be made by a data processor executing program instructions. In resolving base wagers, at least one final player hand to be a modified player winning hand. A modified player winning hand may be based on the playing cards constituting the final player hand, the sum of the values of the playing cards in the final player hand, both the playing cards constituting the final player hand and the sum of those playing cards, or the like. For example, in an optional embodiment, the modified player winning hand is defined based on the value and suit of the playing cards in the final player hand. Additionally or alternatively, modified player winning hands may be defined based on the sum or constitution of the final dealer hand.

A pay table correlating at least one modified player winning hand to a modified award is defined. In an optional embodiment embodied in a device, a pay table may be stored in a memory device communicating with a data processor. Optionally, modified awards may be greater than even money. In a further optional embodiment, modified awards may be greater than the predefined blackjack rate. In an alternate optional embodiment, modified awards may be less than even money.

The modified award is issued when the final player hand matches the modified player winning hand according to the pay table. In one optional embodiment, the modified award is issued without regard to the final dealer hand. That is, in such an optional embodiment, the modified award is issued even if the final dealer hand is a blackjack. In another optional embodiment, the modified award is issued except when the final dealer hand contains playing cards having a sum equal to the target value.

Further objects, features, and advantages of the present invention over the prior art will become apparent from the detailed description of the drawings which follows, when considered with the attached figures.

### BRIEF DESCRIPTION OF THE DRAWINGS

FIG. 1 is a flow chart of a method according to an embodiment of the present invention.

FIG. 2 is a flow chart of a method according to an embodiment of the present invention.

FIG. 3 is a flow chart of a method according to an embodiment of the present invention.

FIG. 4 is a flow chart that continues from the flow charts of FIGS. 2 and 3.

FIG. 5 is a flow chart of a method according to an embodiment of the present invention.

FIG. 6 is a block diagram of a device according to an embodiment of the present invention.

FIG. 7 illustrates a gaming table according to an embodiment of the present invention.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Reference is now made to the figures wherein like parts are referred to by like numerals throughout. The disclosed embodiments include methods and devices for conducting blackjack-type games. More specifically, the disclosed embodiments include methods and devices for conducting games based on the familiar conduct of blackjack with modifications to the pay structure and hand formation process.

The embodiments disclosed herein may be implemented in a live table game, electronic device, or hybrid live and electronic system. For example, the disclosed embodiments could be implemented at: live tables; electronic tables; electronic gaming machines; linked gaming terminal systems; or networked or standalone personal computers, mobile phones, mobile devices, interactive televisions, kiosks, or the like. It is noted that these examples are intended to be illustrative rather than exhaustive.

A method and device according to an embodiment of the present invention may be conducted using a single deck or multiple decks of playing cards, or electronic representations thereof. Moreover, embodiments of the present invention may utilize conventional fifty-two card decks, extended decks (such as decks supplemented with Jokers, or the like), truncated decks (such as Spanish decks or the like), or any other deck constitution. In an optional embodiment implemented on a device, the constitution of the deck(s) may be a game parameter stored in a memory device.

Embodiments of the present invention may include various other game parameters that vary from conventional blackjack. For example, an embodiment of the present invention may include defining one or more of a modified dealer bust hand, an action to be taken in response to a modified dealer bust hand, a modified player winning hand, a pay table associated with modified player winning hands, a discard criterion, and a designated card eligible to be replaced upon satisfying a discard criterion. It is contemplated that these game parameters may vary from embodiment to embodiment.

For example, a modified dealer bust hand may be defined based on the quantity of cards in the final dealer hand when it busts, the value of the card causing the final dealer hand to bust, a combination thereof, or the like. Thus, in one optional embodiment, a modified dealer bust hand may be defined to occur when the final dealer hand busts on the third card (or, depending on the optional embodiment, fourth card, fifth card, sixth card, or so on). In another optional embodiment, a modified dealer bust hand may be defined to occur when the final dealer hand busts when the card causing the final dealer hand to bust is a six (or, depending on the optional embodiment, seven, eight, nine, or so on). In yet another optional embodiment, a modified dealer bust hand may be defined to occur when the total sum of the cards in the final dealer hand, including the playing card causing the bust, is a defined hand sum such as twenty-two (or, depending on the optional embodiment, twenty-three, twenty-four, and so on). Although these examples are directed to the quantity of cards in the final dealer hand when it busts, the value of the card causing the final dealer hand to bust, and the total sum of the busted final dealer hand, it is contemplated that any characteristic of the final dealer hand and/or the playing cards in the final dealer hand may be used to characterize a final dealer hand as a modified dealer bust hand.

Similarly, the action taken in response to a modified dealer bust hand may vary from embodiment to embodiment (as discussed in greater detail below). For example, in an optional embodiment, base wagers may be returned (rather than paid) when a modified dealer bust hand occurs. In alternate optional embodiments, base wagers may be paid, but at a rate of less than even money. These actions would have the effect of increasing the house advantage in the game and thereby offset other changes to the game that would otherwise lower the overall house advantage without the offset of the house advantage elsewhere. In an alternate optional embodiment, base wagers may be paid at greater than even money when a modified dealer bust hand occurs. It is noted that in an optional embodiment, the wagers paid or returned are the base wagers on the blackjack game itself rather than side wagers. That is, the action taken in response to the occurrence of a modified dealer bust hand is taken with respect to the base wager placed for eligibility in the game and which is staked on the outcome of the player hand, rather than a separate side or secondary wager.

A modified player winning hand may be based on the sum of the cards in the final player hand and the playing cards making up the final player hand. In one such optional embodiment, the modified player winning hands may be limited to blackjack (or natural) hands in which the initial player hand, and consequently the final player hand, contains two playing cards that form a total sum of twenty-one, i.e., a ten-value card and an ace. In another optional embodiment, the modified player winning hands could have any sum and/or have any playing cards making up the hand. For example, in one such optional embodiment, modified player winning hands could include hands with a sum of twenty that include suited face cards, hands with a sum of twenty-one in more than two suited cards, or the like.

As may be appreciated, these modified player winning hands could not only include sums close to the target value of twenty-one, but could include any sum or any playing cards, regardless of whether the player hand formed thereby is otherwise considered a high ranking hand in conventional blackjack. That is, any hand could be deemed a modified player winning hand regardless of whether it is normally a winning hand, because defining it to be a modified player winning hand causes certain actions to be undertaken as described below.

A pay table is defined with respect to modified player winning hands. Again, as noted above, the pay table applies to the base wager in the blackjack game rather than a side wager or secondary wager. Thus, the pay table in such an optional embodiment changes the blackjack payouts in the blackjack game as distinguished from creating a separately wagered side game or proposition wager.

In an optional embodiment, modified player winning hands are rewarded at greater than even money. In a further optional embodiment, at least some of the payouts for modified player winning hands are paid at greater than the payout for a blackjack or natural hand. For example, if a game includes a payout for blackjack or natural hands of three to one, at least one of the payouts for modified player winning hands is greater than three to one. The pay table correlates modified player winning hands to payouts for those modified player winning hands. Examples below show pay tables with modified player winning hands and associated payouts. However, these pay tables should be understood to be illustrative rather than limiting since the modified player winning hands and/or payouts could vary in alternate optional embodiments. For example, a pay table may vary depending on the desired house edge and the modified dealer bust hand(s) defined since the selection of modified dealer bust hand(s) define the offset for the decreased house edge created by the pay table for modified player winning hands. Tables 1-3 illustrate example pay tables for modified player winning hands.

TABLE 1

| Player Winning Hand | Payout |
|---|---|
| Blackjack | 3 to 1 |
| Three-card suited 21 | 5 to 10 |
| Suited face cards 20 | 3 for 2 |

TABLE 2

| Player Winning Hand | Payout |
|---|---|
| Suited blackjack | 3 to 1 |
| Any unsuited blackjack | 2 to 1 |
| Dealer bust on a 7 | 6 for 5 |
| Dealer bust on a 6 | 7 for 5 |
| Dealer bust on a face card | Push |

TABLE 3

| Player Winning Hand | Payout |
|---|---|
| Player and dealer hand have identical suited blackjack | 100 to 1 |
| Ace and king of spades blackjack | 25 to 1 |
| Player and dealer have blackjack | 15 to 1 |
| Ace and king suited blackjack | 10 to 1 |
| Suited blackjack | 5 to 1 |
| Other blackjacks | 3 to 1 |

Payouts paid in response to a modified player winning hand may be issued whenever the final player hand is a modified player winning hand without regard to the final dealer hand. Such an optional embodiment would create “instant win” hands not found in conventional blackjack. Alternatively, payouts in response to a modified player winning hand may be made as long as the final player hand outranks the final dealer hand. Such an optional embodiment would retain the possibility that base wagers may be returned rather than paid based on the pay table if the final dealer hand ties the final player hand.

In an optional embodiment, at least one discard criterion is defined. The discard criterion (or criteria) is used to determine if, in certain optional embodiments, a playing card may be discarded from an initial player hand and removed from play, to be replaced by a newly dealt playing card. Although the example below only applies discard criteria to an initial player hand, in a further optional embodiment a discard criterion may also be defined for discarding and replacing a card from the initial dealer hand. Any discard criterion may be defined, including the value of one or both cards in the initial player hand or initial dealer hand, the sum of the cards in the initial player hand or initial dealer hand, the relative values of the cards in the initial player hand or initial dealer hand, or the like. For example, in one optional embodiment, the initial player hand is dealt with one card exposed, referred to as an “up card,” and one card unexposed, referred to as a “down card.” In one such optional embodiment, the player may elect to “burn” a designated card, i.e., discard the designated card from the initial player hand and remove the card from play, if the player's up card is lower than the down card. In another optional embodiment, the player may elect to “burn” the designated card if the player's up card is higher than the down card.

It is contemplated that the designated “burn” card may be either the up card or the down card. In an optional embodiment, the designated card is fixed by the rules of the game, thereby eliminating the player's discretion. Put another way, in an optional embodiment, if the discard criterion is met, an election is received to “burn” a designated card, i.e., remove a designated card from the initial player hand and from play, and the designated card is determined by the rules of the game rather than chosen by the player. In an alternate optional embodiment, the player may be permitted to select which of the cards in the initial player hand is “burned.” In any case, the card that is removed from the initial player hand and removed from play is replaced in the initial player hand by a newly dealt card, thereby re-forming a two-card initial player hand with the card retained from the originally dealt initial player hand and a replacement card dealt after an election is received to “burn” the designated card.

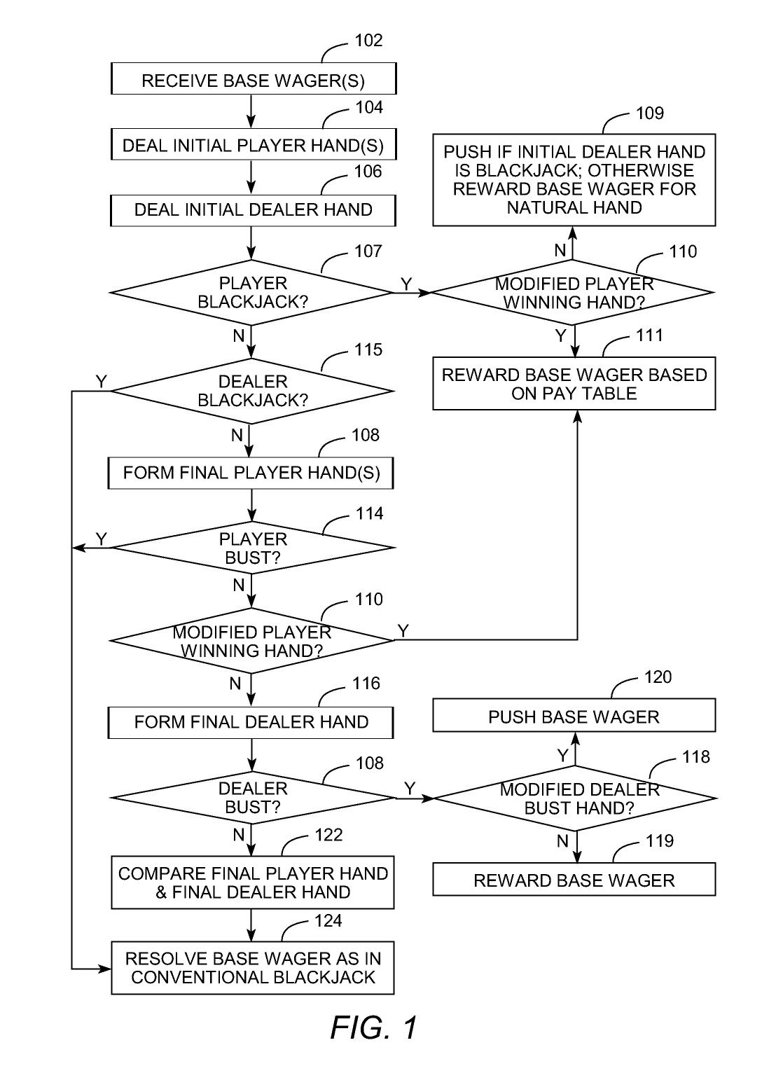

Examples of methods according to an embodiment of the present invention are illustrated in FIGS. 1-4. In one such optional embodiment, base wagers are received 102. As discussed above, in an optional embodiment, the present invention alters the handling of the base wager required for participation in, and staked on the outcome of, the blackjack game and does not require a side wager.

An initial player hand is dealt 104. The initial player hand contains two cards. In an optional embodiment, illustrated in FIGS. 1-4, the initial dealer hand is also dealt 106, although as noted above, under certain rules, it is contemplated that the initial dealer hand may not be dealt until after the final player hands are formed.

Final player hands are formed 108. In one optional embodiment illustrated in FIG. 1, final player hands are formed using at least the conventional blackjack options of hitting or standing (and, optionally, splitting or doubling down). It is contemplated that certain initial player hands may automatically be considered final player hands. For example, a blackjack 107 or natural hand, i.e., an initial hand with two cards having a total sum of twenty-one, may be a final player hand. In one optional embodiment, blackjack hands may be rewarded 109 unless the final dealer hand is also a blackjack holding, as in conventional blackjack. In another optional embodiment, some or all blackjack hands may be modified player winning hands that are automatically and instantly rewarded regardless of the final dealer hand. Such an optional embodiment is described in greater detail below.

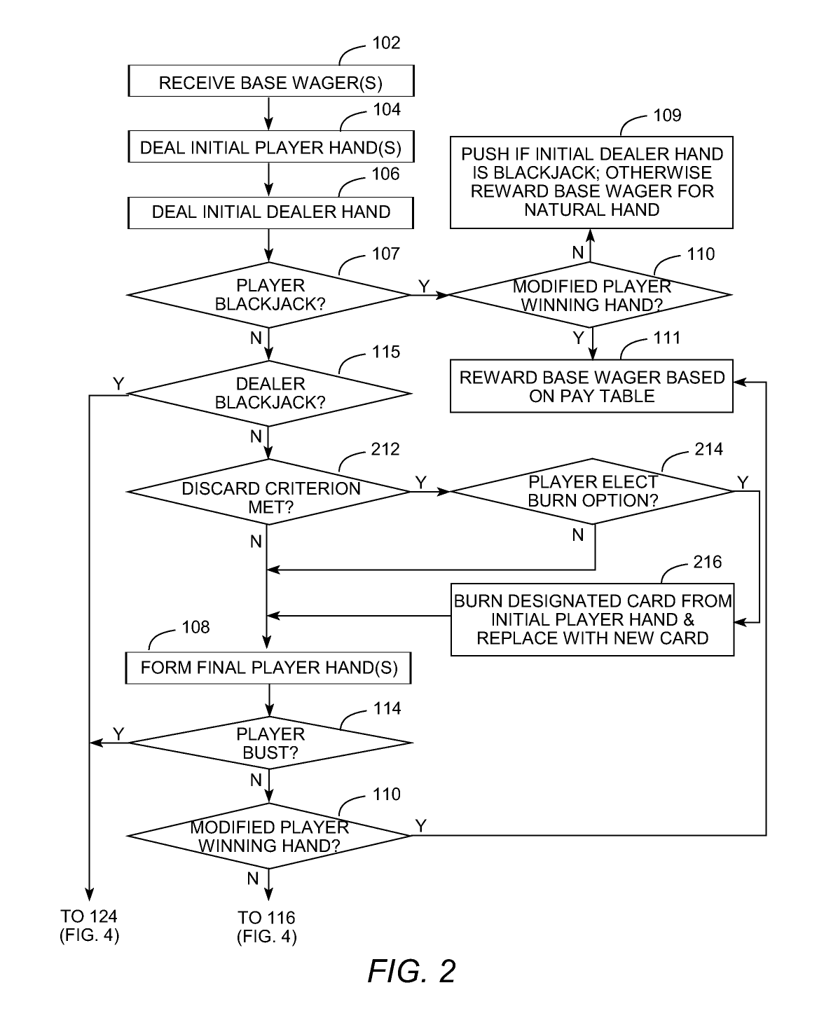

In the optional embodiment illustrated in FIGS. 2-5, the formation of final player hands may be preceded by receiving an election to re-form an initial player hand. That is, in an optional embodiment, a determination may be made 212 whether the initial player hand, or the playing cards that make up the initial player hand, meet one or more discard criteria. If a discard criterion is met, an election may be received 214 to discard a designated playing card from the initial player hand.

In one optional embodiment, the option to “burn” a designated card from the initial player hand may occur before the dealer hand is dealt, i.e., the election is received without knowledge of the initial dealer hand. In another optional embodiment, the option to “burn” a designated card from the initial player hand may occur after at least an exposed or “up” card of a dealer hand is dealt. In such an optional embodiment, the election is received with knowledge of the exposed or “up” card of the initial dealer hand. When elected, the discarded designated playing card is “burned,” i.e., removed from play, and a replacement card is dealt 216 to the initial player hand. A final player hand may then be formed 108 from any re-formed initial player hand(s) using the same options otherwise available, e.g., hit, stand, split, or double down.

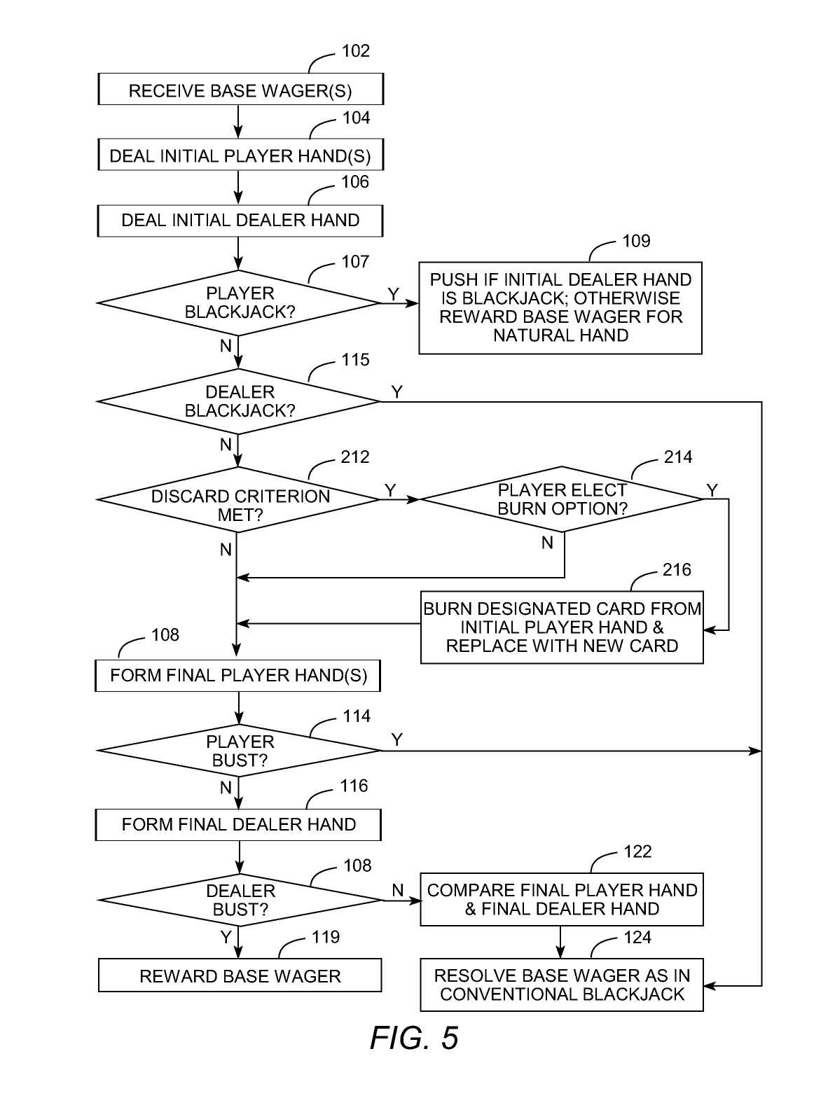

As illustrated in FIG. 5, an optional embodiment of a method and device according to an embodiment of the present invention may consist simply of an otherwise conventional blackjack game that includes one or more discard criteria that permit a playing card in the initial player hand to be burned. As shown in FIG. 5, the “burn” option may occur after the dealing of the initial dealer hand. In an alternate optional embodiment, it is contemplated that the “burn” option may occur before the dealing of the initial dealer hand. It is further contemplated that such a step may also be applied to other blackjack-type games, such as Spanish 21™, Super Fun 21™, Blackjack Switch™, or the like.

In an optional embodiment, if final player hands match 110 a modified player winning hand, then any payout issued 111 to the player is based on a defined pay table that defines modified awards for each modified player winning hand. As noted above, modified player winning hands may be based on blackjack hands or other non-blackjack hands (such as hands containing three or more cards with a total sum of twenty-one, or any other designated sum).

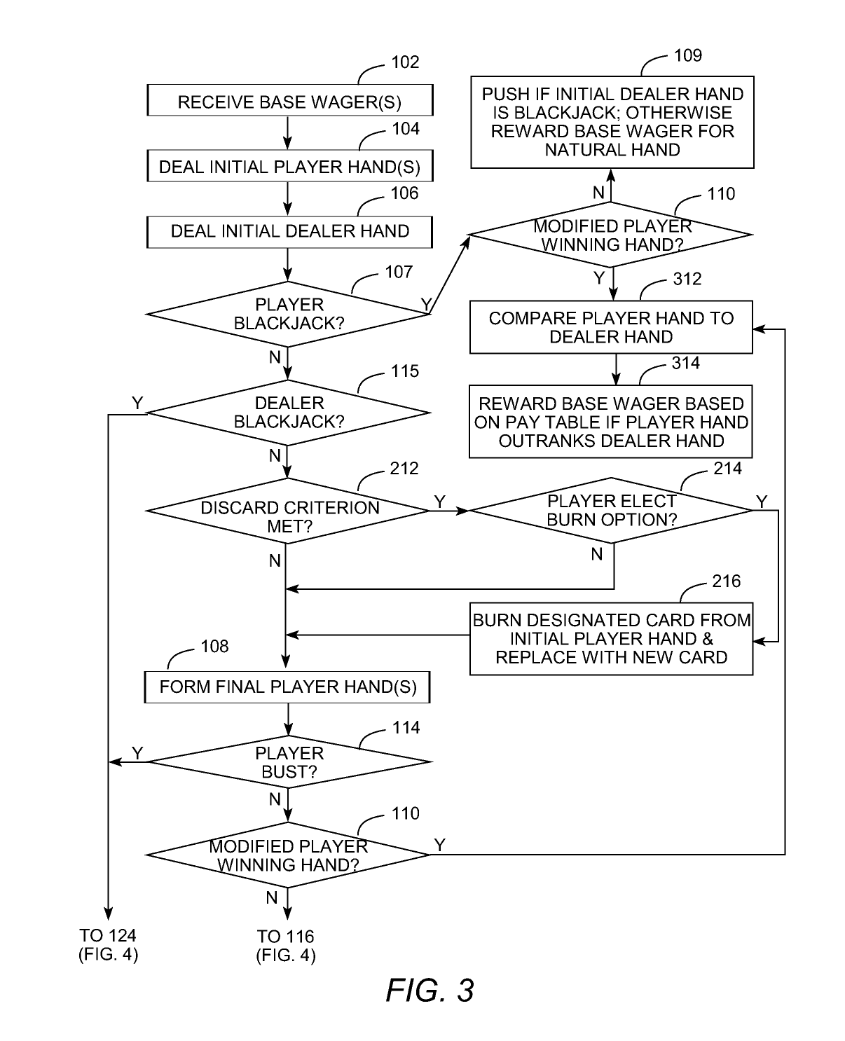

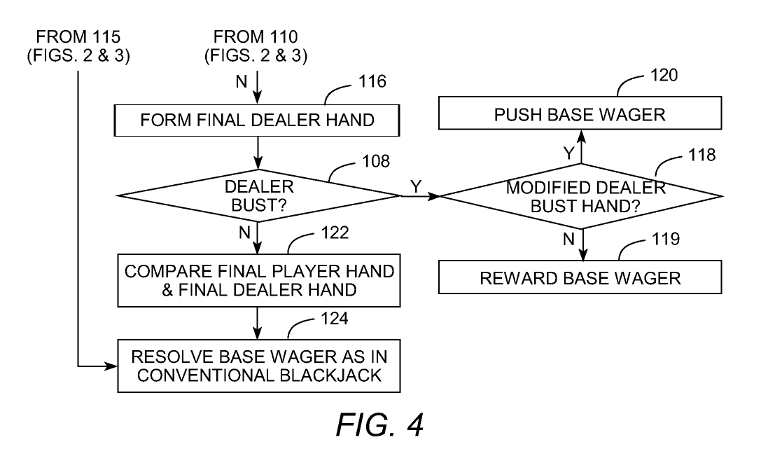

In the optional embodiment of FIGS. 1, 2, and 4, the payout for final player hands that match a modified player winning hand occurs without comparing the final player hand to the final dealer hand and, as such, may be viewed as an instant award. In the optional embodiment of FIGS. 3 and 4, the payout for final player hands that match a modified player winning hand occurs after comparing 312 the final player hand to the final dealer hand and, as such, may be viewed as a modified award for an otherwise winning hand. That is, in the optional embodiment of FIGS. 3 and 4, an award is issued 314 for a modified player winning hand if the final player hand outranks the final dealer hand. In one such optional embodiment, a modified award associated with the modified player winning hand may be issued except when the final dealer hand contains a blackjack, in which case the base wager associated with the final player hand is returned.

If, in the course of forming a final player hand, the total sum of the values of the cards in the player hand exceeds 114 the target value of twenty-one, the base wager associated with that player hand may be collected and play terminated for that player hand in a manner similar to conventional blackjack.

A final dealer hand is also formed 116. In an optional embodiment, a final dealer hand may be formed according to house rules for hitting or standing that are similar or identical to house rules commonly found in conventional blackjack. For example, a typical house rule would be that the dealer hits a hand until the total sum of the cards in the final dealer hand is seventeen or greater, with any aces counted as eleven unless counting the ace as eleven causes the total sum to exceed twenty-one. In another example, a typical house rule would be that the dealer hits a hand until the total sum of the cards in the final dealer hand is seventeen or greater with aces counted as one, or eighteen or greater with aces counted as eleven. If the final dealer hand is a blackjack 115, i.e., the two cards dealt to the initial dealer hand have a total sum of twenty-one, base wagers may be collected except base wagers on final player hands that form blackjack hands, which may be returned, and final player hands that form modified player winning hands, which may be returned or rewarded in various optional embodiments.

If, in the course of forming a final dealer hand, the total sum of the cards in the dealer hand exceeds twenty-one, a determination is made 118 whether the final dealer hand is a predefined modified dealer bust hand. As noted above, the determination of whether a final dealer hand is a modified dealer bust hand may be based on the quantity of cards in the final dealer hand, the value of the card causing the final dealer hand to bust, the total sum of the busted hand, or the like.

If the final dealer hand busts, but is not a modified dealer bust hand, the base wager may be paid 119 even money as in conventional blackjack. However, in response to the occurrence of a modified dealer bust hand, any action other than the even money award in conventional blackjack may be taken. For example, in one optional embodiment, base wagers are paid at less than even money when a modified dealer bust hand occurs. In such an optional embodiment, the payout could range anywhere from zero, i.e., the base wager is returned 120 or pushed but not paid, to any amount less than even money. In another optional embodiment, the base wager may be rewarded at greater than even money. In any case, the occurrence of a modified dealer bust hand may end play.

In an optional embodiment, a side wager may be received. In such an optional embodiment, the side wager may mitigate the action taken in response to a modified dealer bust hand. For example, in one optional embodiment, a side wager may be rewarded when a modified dealer bust hand occurs to offset the reduced or non-existent payout for the base wager when a modified dealer bust hand occurs. Thus, in one such example in which the base wager is returned when a modified dealer bust hand occurs, the side wager may result in a payout of at least even money on the side wager.

If neither a modified player winning hand nor a modified dealer bust hand occurs, the base wager may be resolved in the conventional manner of blackjack, with the final dealer hand compared 122 to the final player hand and the target value of twenty-one and base wagers paid or collected 124 based on the relative differences between the final dealer hand and final player hand and the target value as in conventional blackjack.

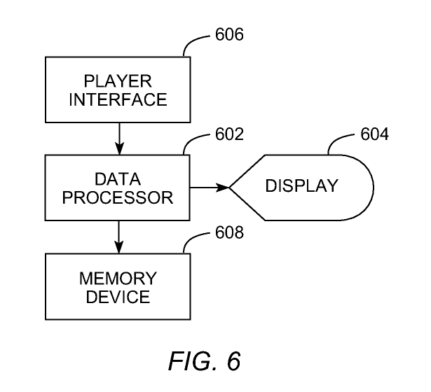

As illustrated in FIG. 6, a method according to an embodiment of the present invention may be implemented using a device. In one optional embodiment, the device only serves to produce random outcomes. Such a random outcome generator may take the form of a playing card shuffler incorporating a random number generator that randomizes playing cards and, optionally, deals randomized hands. Alternatively, a device may perform additional tasks aside from producing random outcomes, such as displaying hands, evaluating and comparing hands, receiving input, and the like.

For example, in one such optional embodiment, a device includes a data processor 602 in communication with a display 604, a player interface 606, and a memory device 608. A base wager is received or designated through a player interface 606. Such a player interface may take any form, including a button panel, keyboard, keypad, or the like. In a further optional embodiment, the player interface 606 and display 604 may be combined into a touchscreen device. In response to the base wager, a random outcome is generated by a random outcome generator. In one such optional embodiment, the random outcome generator is a software, firmware, or hardware random number generator working in concert with a data processor 602 that maps random numbers generated by the random number generator to outcomes, such as playing cards or playing card combinations.

An initial player hand is selected by the random outcome generator and displayed at the display 604. Optionally, a partial initial dealer hand is likewise selected by the random number generator and displayed at the display 604. It is contemplated that the device may be configured for multiple players with each player having his or her own display 604. Alternatively, the device may be configured for multiple players sharing a display 604. In yet another optional embodiment, the device may be configured for a single player and a single display 604. It is also contemplated that a dealer hand may be displayed at a separate display or on the same display as the player hand(s).

In one optional embodiment, a data processor 602 may determine whether a discard criterion, optionally stored at a memory device 608, is satisfied. If so, an election may be received through the player interface 606 to either burn a designated card from the initial player hand and receive a replacement card or proceed with the initial player hand as originally dealt.

A final player hand is formed substantially as described above, with elections to hit or stand (and, optionally, split and double down) received through the player interface 606. In an optional embodiment, a data processor 602 evaluates the final player hand to determine if it matches a modified player winning hand as stored in parameters at a memory device 608. If so, the base wager may be resolved by paying an award based on a pay table stored at a memory device 608. As discussed above, the award may be contingent on a comparison of the final player hand with the final dealer hand or, alternatively, may occur instantly independent of the final dealer hand.

A final dealer hand is formed by the data processor 602. In an optional embodiment, if the final dealer hand is a modified dealer bust hand, the base wager is resolved in a manner different from that of conventional blackjack. Specifically, rather than issuing a reward, base wagers may be paid at less than even money (including being returned and being paid nothing) or paid at greater than even money.

If neither the final player hand nor the final dealer hand bust or form a blackjack, the final player hand is compared to the final dealer hand and the target value of twenty-one by a data processor 602. If the final player hand is closer to the target value than the final dealer hand is, an award is issued by the data processor based on the base wager.

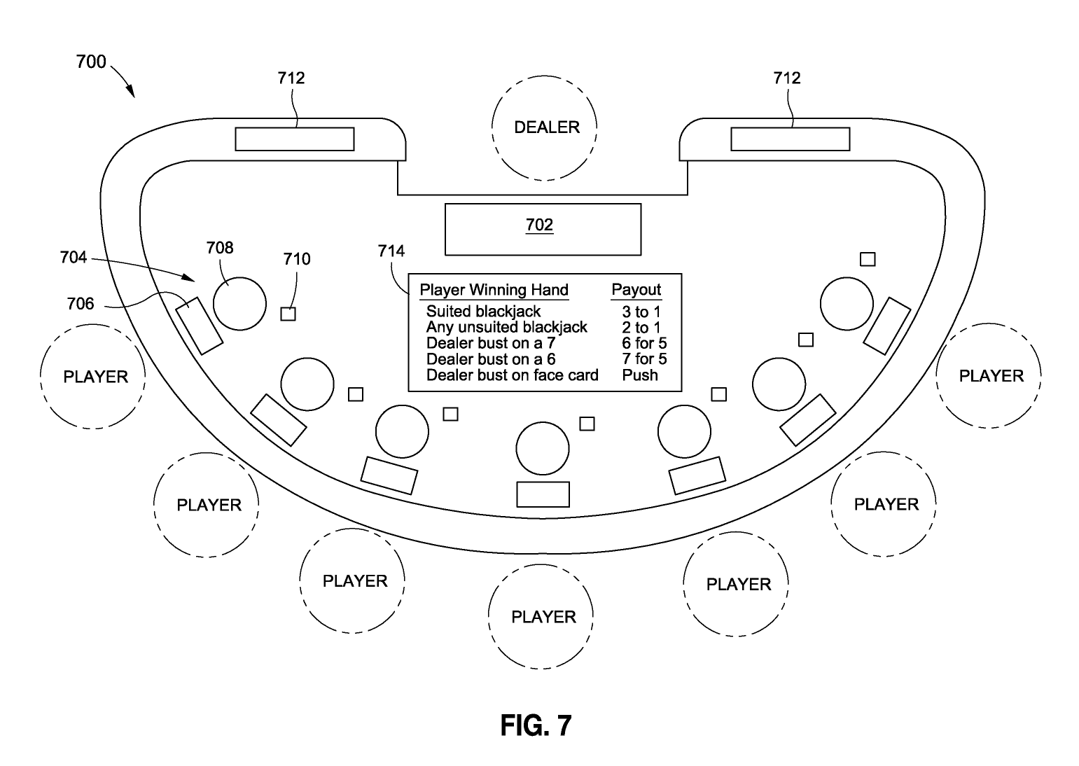

In another optional embodiment, a game playing surface, such as a gaming table or board is provided, as show in FIG. 7. The gaming table 700 (or a surface thereof, such as a “gaming felt” or other covering which is applied to the surface, printing on the gaming table or the like) may include or define a dealer station 702 where a dealer may run a game of blackjack as described above. The dealer station 702 may include an area designated for dealer cards, dealer controls to administer the game, an automatic card shuffler, and the like. The table 700 also includes or defines one or more player stations 704. The player stations 704 may include a card playing area 706, a base wagering area 708, and a side wagering area 710 (each of which might be defined by one or more topographical features of the table, such as a depression or raised area, by printing on the table or a covering, or by other elements). The stations 704 may also include a number of electronic controls for placing wagers, standing, holding, hitting, or otherwise designating game play decisions to the dealer. The wagering areas 708, 710 may be configured to automatically detect a wager via RFID, NFC, or other similar means.

The gaming table 700 may optionally include one or more displays 712. The displays may show game information to the players, such as a payout table, a status of side or bonus wagers, a lottery type status indicator, or the like. There may also be a camera (not shown) disposed above the table. The camera may output images to the display 712 so that the players and other onlooker may easily watch the game as it progresses.

A payout table 714 may also be included on the gaming table 700. The payout table may be integrally formed with the playing surface material or may be removeably added thereto to allow for modifications to the payout table 714. In other embodiments, the payout table 714 may be displayed on a screen imbedded on the surface of the table 700. The screen may be an LCD, LED, plasma, or any other suitable screen for displaying game information on the table to the players.

The size of the gaming board or table 700 may vary, as may its shape, etc. The top or playing surface of the gaming table 700 may preferably be elevated, such as by legs, etc.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method for conducting a card game comprising:
receiving at least one base wager,
dealing an initial player hand of playing cards for each base wager,
dealing an initial dealer hand of playing cards,
forming at least one final player hand from each initial player hand by standing on said initial player hand or receiving at least one additional playing card dealt to said initial player hand, wherein when the sum of the playing cards in a final player hand exceeds a target value, said base wager is collected and play is terminated for said final player hand,
forming a final dealer hand from said initial dealer hand by standing on said initial dealer hand or receiving at least one additional playing card dealt to said initial dealer hand, wherein when a sum of the playing cards in the final dealer hand exceeds a target value, said base wagers are rewarded and play is terminated, and, when the sum of the playing cards in said final dealer hand is less than or equal to said target value, any remaining base wagers are resolved by comparing each final player hand to said final dealer hand and said target value, and wherein when an initial player hand contains playing cards with a sum equal to said target value, said base wager is rewarded at a predefined blackjack rate greater than even money;
defining at least one final dealer hand containing playing cards with a sum that exceeds said target value to be a modified dealer bust hand;
defining at least one final player hand to be a modified player winning hand;
defining a pay table correlating at least one modified player winning hand to a modified award greater than said predefined blackjack rate;
paying less than even money on base wagers when said final dealer hand matches said modified dealer bust hand; and
issuing said modified award when said final player hand matches said modified player winning hand according to said pay table.

2. The method of claim 1 wherein said modified dealer bust hand is defined based on the quantity of playing cards in said final dealer hand.

3. The method of claim 1 wherein said step of paying less than even money on base wagers when said final dealer hand matches said modified dealer bust hand comprises paying nothing and returning base wagers.

4. The method of claim 1 wherein said modified player winning hand is defined based on the value and suit of the playing cards in said final player hand.

5. The method of claim 1 wherein said modified award is issued without regard to said final dealer hand.

6. The method of claim 1 wherein said modified award is issued except when said final dealer hand contains playing cards having a sum equal to said target value.

7. The method of claim 1 further comprising receiving at least one side wager; and issuing an award for each side wager when said final dealer hand is a modified dealer bust hand.

8. A method for conducting a game using a device having a random outcome generator, the method comprising:
receiving at least one base wager;
dealing an initial player hand of playing cards for each base wager based on a random outcome generated by said random outcome generator of the device;
dealing an initial dealer hand of playing cards based on a random outcome generated by said random outcome generator of the device;
forming at least one final player hand from each initial player hand by receiving an indication from the player to stand on said initial player hand or dealing at least one additional playing card to said initial player hand wherein said at least one additional playing card is dealt based on a random outcome generated by said random outcome generator of the device, and wherein when a sum of the playing cards in the final player hand exceeds a target value, collecting said base wager and terminating play for said final player hand;
forming a final dealer hand from said initial dealer hand by standing on said initial dealer hand or dealing at least one additional playing card to said initial dealer hand wherein said at least one additional playing card is dealt based on a random outcome generated by said random outcome generator of the device, wherein if a sum of the playing cards in the final dealer hand exceeds a target value, said base wagers are rewarded and terminating play, and, when the sum of the playing cards in said final dealer hand is less than or equal to said target value, resolving any remaining base wagers by comparing each final player hand to said final dealer hand and said target value, and wherein if an initial player hand contains playing cards with a sum equal to said target value, said base wager is rewarded at a predefined blackjack rate greater than even money;
defining at least one final dealer hand containing playing cards with a sum that exceeds said target value to be a modified dealer bust hand;
defining at least one final player hand to be a modified player winning hand;
defining a pay table correlating at least one modified player winning hand to a modified award greater than said predefined blackjack rate;
returning base wagers when said final dealer hand matches said modified dealer bust hand, without regard to said final player hands; and
issuing said modified award when said final player hand matches said modified player winning hand according to said pay table.

9. The method of claim 8 wherein said modified dealer bust hand is defined based on the quantity of playing cards in said final dealer hand.

10. The method of claim 8 wherein said modified player winning hand is defined based on the value and suit of the playing cards in said final player hand.

11. The method of claim 8 wherein said modified award is issued without regard to said final dealer hand.

12. The method of claim 8 wherein said modified award is issued except when said final dealer hand contains playing cards having a sum equal to said target value.

13. The method of claim 8 further comprising:
receiving at least one side wager; and
issuing an award for each side wager when said final dealer hand is a modified dealer bust hand.

14. A method for conducting a game comprising:
defining at least one discard criterion;
receiving at least one base wager;
dealing an initial player hand of playing cards for each base wager, wherein if an initial player hand contains playing cards with a sum equal to a target value, said base wager is rewarded at a predefined blackjack rate greater than even money;
dealing an initial dealer hand of playing cards;
determining whether any initial player hand meets said at least one discard criterion;
receiving an election for each initial player hand meeting said at least one discard criterion to either (a) continue said game using said initial player hand or (b) discard a designated playing card from said initial player hand, remove said discarded playing card from play, and receive a replacement playing card in said initial player hand;
forming at least one final player hand from each initial player hand by receiving an election from a player to stand on said initial player hand or dealing at least one additional playing card to said initial player hand, wherein if the sum of the playing cards in a final player hand exceeds a target value, said base wager is collected and play is terminated for said final player hand;
forming a final dealer hand from said initial dealer hand by standing on said initial dealer hand or dealing at least one additional playing card to said initial dealer hand, wherein if the sum of the playing cards in a final dealer hand exceeds a target value said base wagers are rewarded and play is terminated; and
when the sum of the playing cards in said final dealer hand is less than or equal to said target value, resolving any remaining base wagers by comparing each final player hand to said final dealer hand and said target value.

15. The method of claim 14 further comprising:
defining at least one final dealer hand containing playing cards with a sum that exceeds said target value to be a modified dealer bust hand;
defining at least one final player hand to be a modified player winning hand;
defining a pay table correlating at least one modified player winning hand to a modified award greater than said predefined blackjack rate;
paying less than even money on base wagers when said final dealer hand matches said modified dealer bust hand, without regard to said final player hands; and
issuing said modified award when said final player hand matches said modified player winning hand according to said pay table.

16. The method of claim 15 wherein said modified dealer bust hand is defined based on the quantity of playing cards in said final dealer hand.

17. The method of claim 15 wherein said modified player winning hand is defined based on the value and suit of the playing cards in said final player hand.

18. The method of claim 15 wherein said modified award is issued without regard to said final dealer hand.

19. The method of claim 15 wherein said modified award is issued except when said final dealer hand contains playing cards having a sum equal to said target value.

20. The method of claim 15 further comprising:
receiving at least one side wager; and
issuing an award for each side wager when said final dealer hand is a modified dealer bust hand.
